(19) United States
(12) Patent Application Publication
(10) Pub. No.: US 2015/0084333 A1
(43) Pub. Date: Mar. 26, 2015

(54) METHOD FOR WELDING TWO EDGES OF ONE OR MORE STEEL PARTS TO EACH OTHER INCLUDING A HEAT TREATMENT STEP AFTER THE WELDING STEP: PENSTOCK OBTAINED WITH SUCH A METHOD

(71) Applicant: ALSTOM Renewable Technologies, Grenoble (FR)

(72) Inventors: Serge PRIGENT, Le Sappey en Chartreuse (FR); Florian DUPARCHY, Grenoble (FR); Arnaud DONCOURT, Le Pont de Claix (FR)

(21) Appl. No.: 14/560,271

(22) Filed: Dec. 4, 2014

Related U.S. Application Data
(63) Continuation of application No. PCT/EP2013/061535, filed on Jun. 5, 2013.

(30) Foreign Application Priority Data
Jun. 5, 2012 (FR) 1255239

(51) Int. Cl. C21D 9/50; F16L 13/02; B23K 31/02

(52) U.S. Cl. CPC C21D 9/505; B23K 31/02; F16L 13/02; C21D 2211/001
USPC 285/288.1; 148/529

(57) ABSTRACT

The present application describes a method for welding two parts to each other. The two parts are made from steel having a high thermomechanical yield strength. The welding method includes a welding step in which a weld bead is created inducing a heat-affected zone to appear. The method also includes a heat treatment step having a heating step, during which at least one portion of the weld bead and the HAZ is gradually heated to a treatment temperature; then a holding step in which the portion of the weld bead and the HAZ is kept at the treatment temperature; then a cooling step in which the HAZ and the weld bead are gradually cooled and pass from the austenitic transformation end temperature to the martensitic transformation end temperature of the steel of the parts in a time between 7.5 s and 8.5 s, and pass from the austenitic transformation end temperature to the martensitic transformation end temperature in a time shorter than 15.5 s. The present application also describes a penstock obtained with such a method.

### CROSS-REFERENCE TO RELATED APPLICATIONS

This application claims priority to PCT/EP2013/061535 filed Jun. 5, 2013, which claims priority to French application 1255239 filed Jun. 5, 2012, both of which are hereby incorporated in their entireties.

### TECHNICAL FIELD

The present invention relates to a method for welding together two edges of one or more parts produced from steel.

More particularly, the invention relates to a method for welding two edges of one or more parts together, the or each part being produced from thermomechanical high yield strength (HLE) steel whose composition simultaneously meets the following conditions:
0.02%≦C≦0.12%, C being of the mass carbon content of the steel, expressed as a percentage by weight, and
0.20%≦C+(Mn+Mo)/10+(Cr+Cu)/20+Ni/40≦0.505%, with C, Mn, Mo, Cr, Cu and Ni being respectively the mass carbon, manganese, molybdenum, chromium, copper and nickel contents of the steel expressed as a percentage by weight, said welding method comprising a welding step during which a weld bead is created, produced from a filler metal, said weld bead producing the secure attachment of the two edges together, the creation of said weld bead inducing the appearance of a heat-affected zone, or HAZ, borne by the steel of the part or parts in proximity to said weld bead.

The field of the invention lies in the field of thermomechanical HLE steel.

### BACKGROUND

The steels of this type exhibit mechanical properties equivalent to the so-called “quenched-tempered” steels, but have a lower carbon content than the latter. This is reflected in particular in more favorable weldabilities by comparison with those of the quenched-tempered steels.

The method creating thermomechanical HLE steels is characterized by the performance of a hot rolling operation followed by a rolling operation at a temperature adjusted below the recrystallization temperature of the austenitic grains and above the solid state phase transformation start temperature.

This operation is then followed by an accelerated cooling, controlled so as to obtain a martensitic structure with bainite content lower than 10%, even lower than 5%.

The thermomechanical HLE steels are thus ready for use in the raw quenched state, that is to say immediately after quenching, because of the precise control of the cooling-rolling cycle.

Because of these interesting properties, the thermomechanical HLE steels are used for many purposes, for example in the field of penstocks intended to convey a pressurized fluid, and which are made up of a number of thermomechanical HLE steel parts welded together, and/or whose parts are produced from plates folded on themselves and then welded.

To obtain such penstocks, welding methods such as those described previously are generally implemented to produce each of the parts, and to weld the parts together. Such methods generally comprise a post-welding stress-relieving heat treatment step, the aim of which is to reduce the residual tensions in the weld bead and in the metal in proximity to the bead.

However, such welding methods present a drawback.

In effect, when welding edges of one or more thermomechanical HLE steel parts together, the steel situated in the vicinity of the weld bead is raised to a high temperature. It then undergoes deformations and a recrystallization followed by a cooling during which its metallurgical structure is altered. This results in particular in degraded mechanical properties in this zone of the parts of the penstock.

Now, the stress-relieving heat treatment makes it possible only to reduce the residual tensions resulting from the local deformations of the material due to the temperature of the filler metal, without compensating the degradation of the mechanical properties because of the change of metallurgical structure of the steel in the heat-affected zone (HAZ).

### SUMMARY OF THE INVENTION

The object of the invention is to propose a welding method that does not present this drawback.

To this end, the invention relates to a welding method of the abovementioned type, characterized in that it also comprises a heat treatment after the welding step, said heat treatment comprising:
a heating step, during which at least a portion of the weld bead and of the HAZ is gradually heated to a treatment temperature lower than the recrystallization temperature of the steel of the or each part, and higher than the austenitization temperature of said steel, then
a holding step, during which the portion of the weld bead and of the HAZ is held at the treatment temperature, then
a cooling step, during which the HAZ and the weld bead are gradually cooled and pass from the austenitic transformation end temperature to the martensitic transformation start temperature of the steel of the parts in a time less than 10 s, and preferably substantially equal to 8 s, and pass from the austenitic transformation end temperature to the martensitic transformation end temperature in a time less than 15.5 s, and preferably equal to 15 s.

According to other aspects of the invention, the method comprises one or more of the following technical features, taken alone or in any technically possible combination:
said portion of weld and of HAZ is contained in a zone of material of given length, centered on the weld bead, extending from the weld bead over the or each part, over a distance of between 1.5 cm and 2.5 cm, and preferably substantially equal to 2 cm, and having a thickness of between 4 mm and 10 mm;
the weld bead and the HAZ are subdivided into portions each belonging to a zone of material, the heating, holding and cooling steps being performed in succession on each of the zones of material;
during the heating step, all of the zones of material are gradually heated simultaneously, during the holding step, the temperature of all the zones of material is kept at the treatment temperature simultaneously, and during the cooling step, all the zones of material are cooled simultaneously;
the treatment temperature is higher than the austenitization temperature of said steel uprated by 50° C., that is to say that said treatment temperature is higher than 1035° C.;
during the heating step, the at least one portion of the weld bead and of the HAZ is heated with a heating speed greater than or equal to 100° C./s;
the holding step has a duration of between 0.5 s and 1.5 s, and preferably substantially equal to 1 s;
the or each part is produced from a steel whose yield strength Rp0.2 is greater than 500 MPa and whose tensile strength Rm is greater than 550 MPa;
the steel of the or each part also meets the condition 0.04≦C≦0.08, C being the mass carbon content of the steel of the or each part expressed as a percentage by weight;
the steel of the or each part also meets the condition 0.20≦C+(Mn+Mo)/10+(Cr+Cu)/20+Ni/40≦0.30, C, Mn, Mo, Cr, Cu and Ni respectively being the carbon, manganese, molybdenum, chromium, copper and nickel contents of the steel expressed as a percentage by weight;
during the heat treatment step, the at least one portion of the weld bead and of the HAZ is heated at least by induction.

Furthermore, the invention relates to a penstock intended to convey a pressurized liquid, characterized in that it comprises two parts welded together by a welding method as described above or a part formed by a welding method as described above.

### BRIEF DESCRIPTION OF THE DRAWINGS

The invention will be better understood on reading the following detailed description, given purely as a nonlimiting example, and with reference to the attached figures, in which:

FIG. 1 is a schematic representation of a penstock according to the invention;

FIG. 2 is a schematic representation of a weld zone between two parts of the penstock of FIG. 1 along the plane I-I;

FIG. 3 is a block diagram of a welding method according to the invention;

FIG. 4 is a schematic representation of the temperature variation in the zone of the weld of FIG. 2 during the welding method of FIG. 3; and

FIG. 5 is a schematic representation of a weld zone obtained by a welding method according to a variant of the invention.

### DETAILED DESCRIPTION

Referring to FIG. 1, a penstock 10 according to the invention is intended to be used to convey a pressurized liquid, for example water, and comprises a plurality of parts 12 made of thermomechanical HLE steel.

As indicated previously, the thermomechanical HLE steels exhibit mechanical properties close to the so-called quenched-tempered steels, hereinafter called “QT steels”, but with a substantially lower carbon content.

This is reflected in a good matching of these thermomechanical HLE steels to the welding.

The creation of thermomechanical HLE steels is differentiated from that of QT steels in that it comprises the performance of a hot rolling operation followed by a rolling operation at a temperature that is both lower than the recrystallization temperature of the austenitic grains and higher than the solid state phase transformation start temperature. This second rolling operation is itself followed by a cooling operation that is accelerated and controlled in order to obtain a martensitic structure with low bainite content, for example less than 10%, and preferentially less than 5%.

The thermomechanical HLE steels are so-called “as-quenched” steels, that is to say that they meet conditions of use immediately after quenching.

Hereinbelow, “HLE” should be understood to mean that the yield strength of the steel concerned is greater than 460 MPa.

Referring to FIG. 1, the penstock 10 given by way of nonlimiting example comprises a succession of juxtaposed parts 12, two edges 13 of two successive parts 12 being welded together in a weld zone 14.

Each of the parts 12 is produced from thermomechanical HLE steel.

More specifically, each of the parts 12 is produced from thermomechanical HLE steel whose composition meets the following conditions (A) simultaneously:
0.02%≦C≦0.12%, C being the carbon content of the thermomechanial HLE steel, expressed as a percentage by weight, and
0.20%≦C+(Mn+Mo)/10+(Cr+Cu)/20+Ni/40≦0.505%, with C, Mn, Mo, Cr, Cu and Ni being respectively the carbon, manganese, molybdenum, chromium, copper and nickel content of the thermomechanical HLE steel expressed as a percentage by weight.

Preferably, the composition of the HLE steel of the parts meets at least one of the following conditions:
0.04≦C≦0.08, and
0.20≦C+(Mn+Mo)/10+(Cr+Cu)/20+Ni/40≦0.30.

The thermomechanical HLE steels that meet the conditions (A) exhibit a recrystallization temperature substantially equal to 1200° C. and an austenitization temperature, called AC3, substantially equal to 985° C. Furthermore, preference is given to the use of a steel exhibiting a yield strength Rp_{0.2} greater than 500 MPa and a tensile strength Rₘ greater than 550 MPa.

Preferentially, all the parts 12 of the pipe 10 have the same composition meeting the conditions (A).

Furthermore, the composition of the steel of the parts 12 of the pipe 10 generally meets all the following conditions, which are typical of the thermomechanical HLE steels:

Si≦0.600; Mn≦2.10; P≦0.02; S≦0.008; Al≦0.20; Cr≦1.50; Ni≦2.00; Mo≦0.50; V≦0.20; Nb≦0.09; Ti≦0.22; and B≦0.005, in which “E” corresponds to the percentage by weight of the element “E” in the metal, the rest being impurities resulting from the creation.

As a variant, at least two parts 12 of the pipe 10 have mutually distinct compositions that both meet the conditions (A).

Each part 12 has a generally tubular form and is produced from thermomechanical HLE steel that meets the conditions (A).

Each part 12 has an outer face intended to be in contact with the air in the case of overhead pipes or in contact with the rock or concrete in the case of buried pipes, and an inner face intended to be in contact with the fluid conveyed by the penstock 10.

Each part 12 is either a steel plate, or a part produced by forging or a part produced by rolling.

For example, at least one of the parts 12 of the pipe 10 is produced from a steel plate that meets the conditions (A), which is rolled and then bent. The longitudinal edges of the plate are then welded together to form said part.

Each part 12 has a thickness e of between 10 mm and 100 MM.

The parts 12 have a diameter of between 1 and 6 m, and a length of between 1 m and 10 m. The parts 12 of one and the same pipe which are welded together have substantially the same diameter in their weld zone 14.

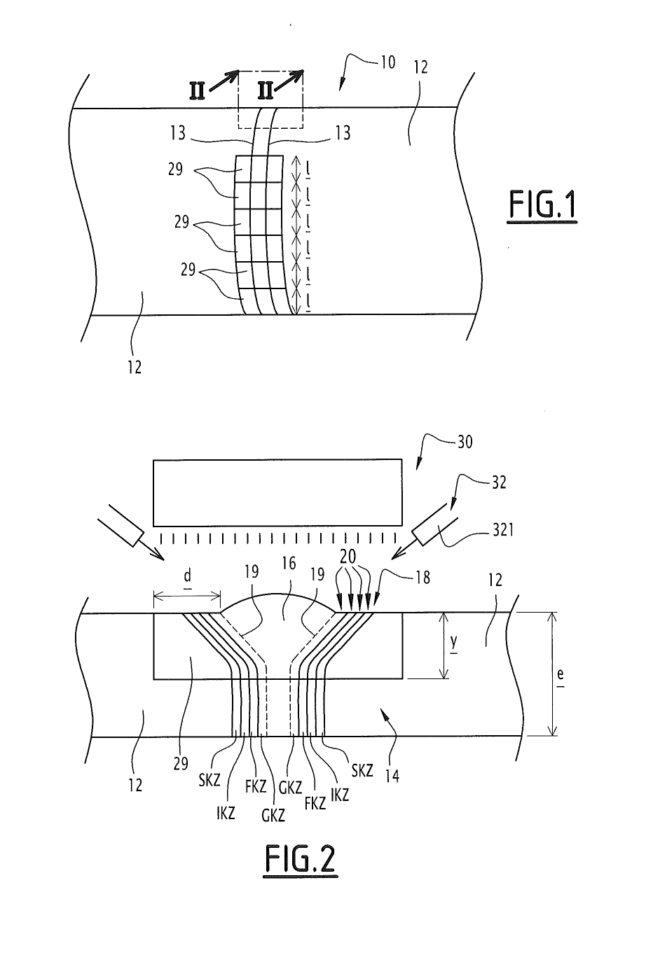

FIG. 2 illustrates the weld zone 14 between two edges 13 belonging respectively to two parts 12 of the penstock 10.

The weld zone 14 comprises a Y-configuration weld bead and a heat-affected zone 18, hereinafter called “HAZ” 18.

The weld bead 16 corresponds to a joint securing the two edges 13 together. The bead 16 extends over the entire thickness e of the parts 12.

In practice, to improve the quality of the welding of the two parts 12, chamfers 19 are formed on the edges 13 of the two parts 12, so as to facilitate the passage of the filler metal between these two edges 13 and prevent the formation of air pockets in the weld bead 16.

The weld bead 16 consists of a filler metal having a composition that meets the conditions (A) but whose mass content notably of molybdenum Mo and nickel Ni is greater than that of the base metal of the parts 12.

The filler metal typically has the following composition, expressed as a percentage by weight: C=0.13; Mn=1.7; Ni=2.1; Mo=0.6; Cr=0.3. The composition of the base metal is then chosen in such a way as to guarantee the mechanical properties of the welded joint.

For the welding of the two edges 13 of the parts 12, the filler metal is initially raised to a temperature higher than its melting point, then arranged in liquid form at the junction of the two edges 13 placed facing one another. The filler metal spreads and fills the Y-shaped space which is thus delimited by the two parts 12, and is then cooled. During its cooling, the filler metal solidifies then hardens to form the weld bead 16 and then produces the secure attachment of the two edges 13 together over the entire thickness e.

The HAZ 18 concerns both of the parts 12 and comprises a plurality of zones 20 which are differentiated from one another by the temperature prevailing therein during the formation of the weld bead 16.

In effect, because of the heat given off by the molten filler metal and which is propagated by conduction in the two parts 12, the temperature of the steel in proximity to the weld bead 16 undergoes variations which decrease with distance away from the weld bead 16, and which induce deformations (not represented) and alterations of the structure of the steel of the HAZ 18.

These alterations of the structure of the steel lead to mechanical properties that are degraded compared to those exhibited by the base metal, that is to say the steel prior to the welding.

Within the HAZ 18, at least the following zones 20 can be distinguished:
a so-called “GKZ” zone (“coarse grain zone”) in contact with the weld bead 16,
a so-called “FKZ” zone (“fine grain zone”) in contact with the GKZ zone,
a so-called “IKZ” zone (“intercritical annealed zone”) in contact with the FKZ zone, and
a so-called “SKZ” zone (“subcritical annealed zone”) in contact with the IKZ zone.

As will be seen hereinbelow, the temperature in the zones 20 of the HAZ during the welding method varies, inducing undesirable alterations to the specific mechanical properties of each of the zones 20 of the HAZ 18.

As will have been understood, the object of the invention is to propose a method for welding 22 two edges of one or more parts 12 together which makes it possible to compensate the degradation of the mechanical properties of the steel in the HAZ 18 because of the raising of the temperature in the steel of the part or parts 12 in proximity to the weld bead 16, and do so by means of a quenching treatment which will be described hereinbelow.

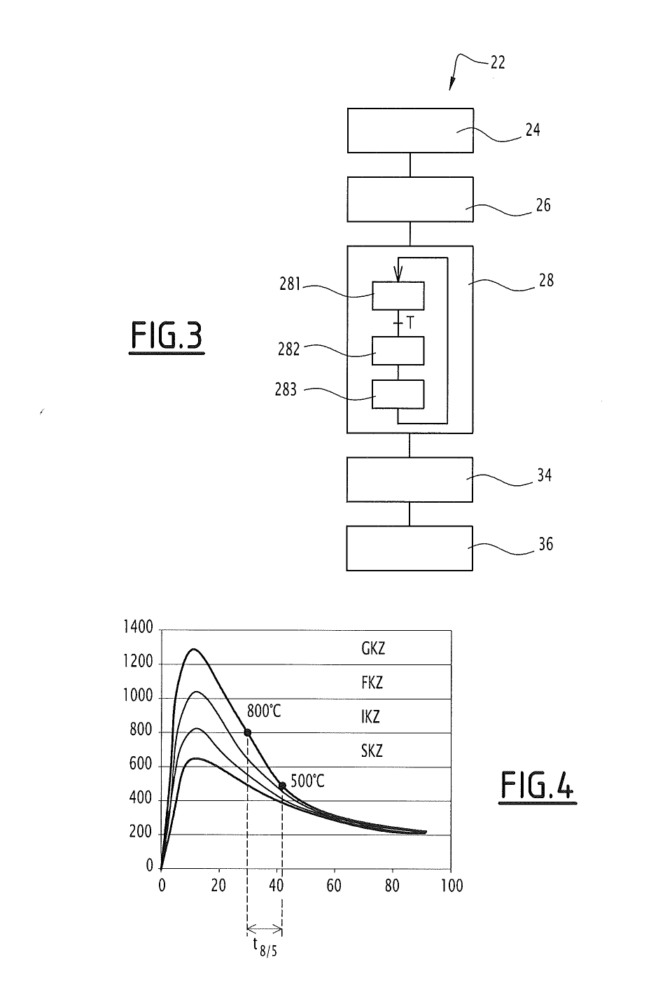

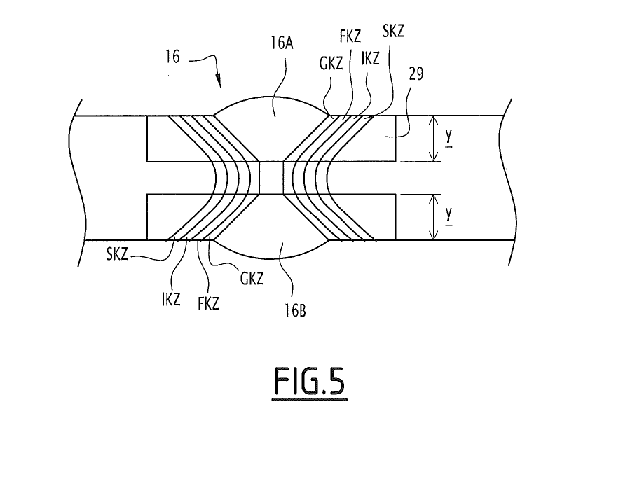

The welding method 22 according to the invention will now be described with reference to FIGS. 3 and 4, and in the case of the welding of two parts 12 together.

Referring to FIG. 3, the method for welding 22 together the edges 13 of two parts 12 produced from thermomechanical HLE steel that meets the conditions (A) comprises a welding step 24, during which the two edges 13 are arranged facing one another and the weld bead 16 is created, as described above.

The weld bead 16 is, for example, created by means of an electrical arc generated by an electrode under an active gas flow (or “MAG” method), such as a mixture of hydrogen and carbon dioxide. The edges 13 of the two parts 12 are, for example, arranged on a ceramic support to perform the welding.

During the welding step 24, the heat given off by the molten filler metal is conducted in the two parts 12, such that the temperature in the zones 20 of the HAZ increases substantially.

More specifically, during the welding step 24:
the temperature reached in the GKZ zone lies between 1050° C. and 1300° C.,
the temperature reached in the FKZ zone lies between 900° C. and 1050° C.,
the temperature reached in the IKZ zone lies between 650° C. and 900° C., and
the temperature reached in the SKZ zone lies between 300° C. and 650° C.

Referring to FIG. 4, which illustrates the temperature variations (in ° C.) observed in the zones of the HAZ 18 and induced by the welding of the two edges 13 together as a function of time (in s), it is found that the temperature of the GKZ zone passes above the recrystallization temperature of the steel of the parts 12 (substantially equal to 1200° C.) before cooling.

During this cooling, the time taken by the steel of the GKZ zone to pass from 800° C. to 500° C. determines the final structure of the steel of this GKZ zone.

Hereinbelow, the time taken by a zone 20 of the HAZ 18 to pass from 800° C. to 500° C. will be denoted “T8/5” and the time taken by a zone 20 of the HAZ 18 to pass from 800° C. to 400° C. will be denoted “T8/4”.

The final structure of the steel is conventionally modeled by a curve called “continuous cooling transformation curve” of the steel concerned.

This continuous cooling transformation curve delimits areas that each correspond to the presence of one or more of the following phases of the steel in its final structure: perlite, martensite, ferrite and bainite.

Depending on the speed of cooling of the steel, the corresponding curve passes through one or more of these zones, such that the final structure of the steel comprises the corresponding phase or phases, which will determine its mechanical properties.

Referring to FIG. 4, it will be observed that, during the welding of the two edges 13 together, the GKZ zone exhibits a time T8/5 substantially equal to 15 s, which leads to a final structure for the GKZ zone that simultaneously comprises martensite, bainite and ferrite.

The same applies for the IKZ zone, which, for its part, exhibits a time T8/5 substantially equal to 20 s, which is also reflected in the presence of perlite in its structure.

These structures are reflected in mechanical properties that are substantially degraded compared to the base of steel, that is to say the steel of the parts 12 not heat-affected by the weld.

It has for example been measured that a thermomechanical HLE steel of a composition that meets (A) exhibiting a time T8/5 greater than 50 s exhibited a yield strength and a tensile strength only half of those of a steel of the same composition but exhibiting a time T8/5 less than 7 s.

More specifically, it has been measured that, after the welding step 24, at least certain regions of the IKZ and GKZ zones exhibited degradations of their mechanical properties of the order of 10 to 20%, even 50% or more in some cases, as indicated previously.

Following this welding step 24, a finishing step 26 is carried out during which the weld bead 16 and its vicinity are subjected to one or more mechanical treatments aiming to eliminate the excess filler metal, correct the alignment defects, the undercuts (that is to say any lack of material at the welded joint/base metal interface), and generally, the geometrical defects of the weld bead 16.

These mechanical treatments are, for example, carried out by machining, grinding, or hammering (for example by pneumatic impact hammering, also known as “pneumatic impact treatment”), or even shot-blasting, which consists in bombarding the surface to be treated with microballs of metal, glass or ceramic, to modify the surface structure thereof. A number of these treatments can be performed in succession.

The result of this finishing step 26 is that the mechanical properties of the weld zone 14 are enhanced, by comparison with a weld zone 14 for which no mechanical treatment is performed.

After the finishing step 26, according to the invention, during a heat treatment step 28, the weld bead 16 and its vicinity are subjected to a quenching treatment.

To do this, the weld bead 16 and the HAZ 18 are subdivided into zones of material 29 each comprising a portion of the weld bead 16 and the corresponding portion of the HAZ 18.

Referring to FIGS. 1 and 2, each zone of material 29 is centered on the weld bead 16, extends from the weld bead 16 over both the parts 12, and does so over a distance d of between 1.5 cm and 2.5 cm, and preferably substantially equal to 2 cm.

Each zone of material 29 also has a length l along the circumference of the parts 12 and a thickness y of between 4 mm and 10 mm.

In other words, each zone of material 29 notably comprises a portion of length l and of thickness y of the weld bead 16 and the portion of the HAZ 18 in contact with this portion of the weld bead 16.

During the heat treatment step 28, for each zone of material 29, the zone of material 29 is heated and then cooled gradually using heating means 30 and cooling means 32 respectively.

More specifically, the heat treatment step 28 comprises, for each zone of material 29:
a step 281 of heating of the zone of material 29,
a step 282 of maintaining the temperature in the zone of material 29, and
a step 283 of cooling of the zone of material 29.

During the heating step 281, the zone of material 29 is heated with the heating means 30 to a treatment temperature T which is:
lower than the recrystallization temperature of the thermomechanical HLE steel of the two parts 12, the effect of which is that the thermomechanical HLE nature of the steel of the zone of material 29 is retained, and
higher than the austenitization temperature of this thermomechanical HLE steel uprated by 50° C., which substantially corresponds to 1035° C. and which has the effect of transforming the crystallographic structure of the zone of material 29 into at least 70% austenite, and preferably substantially all austenite.

The heating means 30 comprise a coil of a length substantially equal to l fed by a generator delivering a power of between 40 and 50 kW (not represented) and are adapted to heat by induction the zones of material 29 one at a time with a heating speed greater than or equal to 100° C./s. To do this, the heating means 30 are arranged over a zone of material 29 at a distance substantially equal to 2 mm during the heating 281 and holding 282 steps.

The length l of the coil of the heating means 30 then determines the subdivision of the weld zone into a zone of material 19, the length l of the zones of material 29 being chosen to be equal to that of the coil.

During the heating step 281, the heating speed applied to the zone of material 29 is preferably greater than 100° C./s, which has the effect of not extending the HAZ 18. In effect, a heating speed of less than 100° C./s would have the effect of favoring the conduction of the heat in the regions neighboring the zone of material 29 and thus extend the HAZ 18.

During the holding step 282, the zone of material 29 concerned is held at the treatment temperature T for a time of between 0.5 s and 1.5 s, and preferably substantially equal to 1 s. This time has the effect of limiting the increase in the size of the grains in the zone of material 29, such an increase not being desirable.

During the cooling step 283, the zone of material 29 concerned is gradually cooled via the cooling means 32 from the treatment temperature T to ambient temperature. As a variant, the cooling of the zone of material 29 is controlled to 400° C., then left free from 400° C. to ambient temperature.

To do this, the cooling means 32 comprise pipes 321 oriented toward the zone of material 29 and via which gas is propelled toward the zone of material with a controlled flow rate. The propelled gas then dissipates the heat of the zone of material 19 by convection. It should be noted that it is preferable for the cooling means 32 to use gas rather than water, water being likely to damage the heating means 30 which are located in proximity.

More specifically, during the step 283, the zone of material 29 is cooled via the cooling means 32 in such a way that:
the time taken by the zone of material 29 to pass from the austenitic transformation end temperature to the martensitic transformation start temperature is less than or equal to 10 s, and preferably substantially equal to 8 s, that is to say that the time T8/5 of the zone of material 29 is less than 10 s and preferably substantially equal to 8 s, and
the time taken by the zone of material 29 to pass from the austenitic transformation end temperature to the martensitic transformation end temperature is less than or equal to 15.5 s, and preferably equal to 15 s, that is to say that the time T8/4 is less than or equal to 15.5 s, and preferably equal to 15 s.

It should be noted that the minimum value of the times T8/5 and T8/4 is governed by the cooling technique implemented. Thus, for gas cooling means, these minimum values are of the order of a second for T8/5, and a few seconds for T8/4.

These T8/5 and T8/4 values have the effect that the zones 20 of the HAZ 18 and the weld bead of the zone of material 29 have a final structure made up of martensite and bainite, with a martensite content greater than 90% and a bainite content less than 10%, and preferentially with a martensite content greater than 95% and a bainite content less than 5%.

This final structure of the steel of the HAZ 18 exhibits better mechanical properties than those that it exhibited following the welding step 24.

It has thus been measured that the method according to the invention made it possible to compensate the degradations of the mechanical properties of the zones of the HAZ, such that the metal of the weld zone, of the weld bead and of the HAZ exhibited mechanical properties degraded by less than 10% compared to the base metal.

This compensation by virtue of the heat treatment step in the welding method according to the invention is a function of the carbon content of the base metal, and of its content in terms of alloy elements and carbides, as well as the size of the grains and of the zone of the HAZ 18 in which it is located.

The cooling of the zone of material 29 between 400° C. and ambient temperature can then be controlled or not without preference, this cooling not involving any alteration of the zone of material 29.

Once a given zone of material 29 has undergone the heating 281, holding 282 and cooling 283 steps, an adjacent zone of material 29 is in turn subjected to these same steps 281, 282, 283. The heat treatment step ends once all the zones of material 29 have been subjected to the steps 281, 282 and 283.

The heat treatment is thus performed in succession over all the zones of material 29 until all of the weld bead 16 and of the HAZ 18 has been heat treated.

Following the heat treatment step 28, an inspection step 34 takes place, during which the structure obtained following the welding of the two edges 13 together is inspected destructively and/or non-destructively.

This inspection step 34 comprises one or more of the following non-destructive operations:
a visual examination, during which the external state of parts 12 and of the weld bead 16 is visually examined,
a dye-penetrant operation, during which a visible liquid is applied to the inspected zone and then revealed,
a radiological inspection operation, via the emission of X or gamma rays, and
a magnetic flow detection inspection operation.

The inspection step 34, when it involves a destructive inspection, comprises one or more of the following destructive operations:
a mechanical test, during which the part being tested is subjected to forces culminating in the destruction of the part, and that makes it possible to obtain, among other things, the tensile strength Rm of the part, its yield strength Rp0.2, it elongation at break, etc.,
a hardness test, such as the Vickers or Brinell test,
a metallographic test during which the structure of the metal is observed under a microscope,
a Charpy impact test, and
a fatigue test with and without notching.

Following the inspection step 34, an anti-corrosion treatment step 36 is performed, during which the weld zone 14 is subjected to an anti-corrosion treatment.

More specifically, during the anti-corrosion treatment step, the weld bead 16 and the HAZ 18 are galvanized by zinc spraying.

Then, the weld bead and the HAZ are painted with a paint suited to the conditions in which the bead and the HAZ are intended to be located:
for the portion of the weld bead and of the HAZ intended to be in contact with the air, the paint used is, for example, a paint suited to atmospheric corrosivity of category 4 or 5 according to the ACQPA (Association for the Certification and Qualification of Anticorrosion Paint) classification, and
for the portion of the weld bead and of the HAZ intended to be in contact with water, the paint used is, for example, a paint suited to corrosivity of category Im2 according to the ACQPA classification.

The welding method 22 according to the invention makes it possible to compensate the degradations of the mechanical properties of the HAZ 20 by virtue of the increase in temperature which is applied thereto during the welding of two parts 12 of thermomechanical HLE steel of a composition that meets the conditions (A).

Furthermore, the method 22 is suitable for parts of large sizes, in as much as it is based on the heating and the cooling of the weld bead and of the HAZ on the move, and not by local static quenching.

Preferentially, the heat treatment step 28 is performed both on the portion of the weld zone 14 situated on the side of the inner face of the parts 12, and on the portion situated on the side of the outer face of the parts 12.

In practice, the heat treatment step cannot always be performed on the portion of the weld zone 14 situated on the side of the outer face 12, notably when the welding of the parts 12 is performed in the well receiving the pipe 10.

As a variant, the heat treatment step 28 comprises carrying at a local static treatment during which the quenching treatment is performed simultaneously on all the zones of material 29.

For this, the heating means 30 comprise induction heating means comprising a coil of a length greater than the circumference of the parts 12, which is then arranged level with the weld bead 16 and the HAZ 18. The cooling means 32 are also adapted to perform the cooling of all of the heated zone by the cooling means.

As a variant, the heating means 30 also comprise a hybrid laser radiation heating device coupled to the coil.

As a variant, the heating means 30 are adapted to heat the weld bead 16 and the HAZ 20 by natural or forced convection, or by resistivity.

As a variant, the weld bead 16 is generally X-shaped and has an outer portion 16A intended to be in contact with air, rock or concrete and an inner portion 16B intended to be in contact with the fluid conveyed by the pipe. This type of weld is, for example, implemented when the parts 12 have a significant thickness, for example greater than 10 mm.

During the heat treatment step 28, the heating 281, holding 282 and cooling 283 steps are then carried out on zones of material 29 centered on the outer portion 16A of the weld bead 16, then on zones of material 29 centered on the inner portion 16B of the weld bead 16.

Also as a variant, during the welding step 24, the weld bead 16 is produced by multiple passes, during each of which molten filler metal is placed in the weld zone. Each pass has the effect of affecting its vicinity by heat, this affected vicinity being subsequently again affected by heat by the subsequent passes. Thus, the HAZ 18 of the weld bead 16 is made up of all the zones affected by heat by at least one pass, the structure of said HAZ having a complex structure because of the heat effect on certain regions of the vicinity of the weld bead 16 by a plurality of distinct passes.

In the context of this variant, the heat treatment step 28 is performed on the move or in a local static manner in the same way as previously.

The welding method 22 according to the invention and the above variants have been described in the context of the welding of two parts 12 together.

As will have been understood, the welding method 22 described and the variants described can be applied to the scenario in which two edges of one and the same part 12 produced from steel as described above are welded together.

Thus, one or more of the parts 12 of the pipe 10 are, for example, made up of a plate that is rolled and then bent. Two edges of the plate are then welded together along a longitudinal line by means of the welding method 22 according to the invention to form the part 12 concerned. The welding method 22 then improves the mechanical strength of the weld zone present on the part or parts 12 of the penstock 10.

It is also possible to envisage welding, by the method according to the invention, more than two parts together during one and the same operation.

1. A method for welding two edges of one or more parts together, the or each part being produced from thermomechanical high yield strength steel whose composition simultaneously meets the following conditions:
0.02%≦C≦0.12%, C being the mass carbon content of the steel, expressed as a percentage by weight, and
0.20%≦C+(Mn+Mo)/10+(Cr+Cu)/20+Ni/40≦0.505%, with C, Mn, Mo, Cr, Cu and Ni being respectively the mass carbon, manganese, molybdenum, chromium, copper and nickel contents of the steel expressed as a percentage by weight,
said welding method comprising a welding step during which a weld bead is created, produced from a filler metal, said weld bead producing the secure attachment of the two edges together, the creation of said weld bead inducing the appearance of a heat-affected zone, or HAZ, borne by the steel of the part or parts in proximity to said weld bead, and
a heat treatment step after the welding step, said heat treatment step comprising:
a heating step, during which at least a portion of the weld bead and of the HAZ is gradually heated to a treatment temperature lower than the recrystallization temperature of the steel of the or each part, and higher than the austenitization temperature of said steel, then
a holding step, during which the portion of the weld bead and of the HAZ is held at the treatment temperature, then
a cooling step, during which the HAZ and the weld bead are gradually cooled and pass from the austenitic transformation end temperature to the martensitic transformation start temperature of the steel of the parts in a time less than 10 s, and preferably substantially equal to 8 s, and pass from the austenitic transformation end temperature to the martensitic transformation end temperature in a time less than 15.5 s, and preferably equal to 15 s.

2. The method as claimed in claim 1, wherein said portion of weld and of HAZ is contained in a zone of material of given length, centered on the weld bead, extending from the weld bead over the or each part, over a distance of between 1.5 cm and 2.5 cm, and preferably substantially equal to 2 cm, and having a thickness of between 4 mm and 10 mm.

3. The method as claimed in claim 2, wherein the weld bead and the HAZ are subdivided into portions each belonging to a zone of material, the heating, holding and cooling steps being performed in succession on each of the zones of material.

4. The method as claimed in claim 2, wherein during the heating step, all of the zones of material are gradually heated simultaneously, that during the holding step, the temperature of all the zones of material is kept at the treatment temperature simultaneously, and during the cooling step, all the zones of material are cooled simultaneously.

5. The method as claimed in claim 1, wherein the treatment temperature is higher than the austenitization temperature of said steel uprated by 50° C., that is to say that said treatment temperature is higher than 1035° C.

6. The method as claimed in claim 1, wherein during the heating step, the at least one portion of the weld bead and of the HAZ is heated with a heating speed greater than or equal to 100° C./s.

7. The method as claimed in claim 1, wherein the holding step has a duration of between 0.5 s and 1.5 s, and preferably substantially equal to 1 s.

8. The method as claimed in claim 1, wherein the or each part is produced from a steel whose yield strength Rp0.2 is greater than 500 MPa and whose tensile strength Rm is greater than 550 MPa.

9. The method as claimed in claim 1, wherein the steel of the or each part also meets the condition 0.04≦C≦0.08, C being the mass carbon content of the steel of the or each part expressed as a percentage by weight.

10. The method as claimed in claim 1, where the steel of the or each part also meets the condition 0.20≦C+(Mn+Mo)/10+(Cr+Cu)/20+Ni/40≦0.30, C, Mn, Mo, Cr, Cu and Ni respectively being the carbon, manganese, molybdenum, chromium, copper and nickel contents of the steel expressed as a percentage by weight.

11. The method as claimed in claim 1, wherein during the heat treatment step, the at least one portion of the weld bead and of the HAZ is heated at least by induction.

12. A penstock intended to convey a pressurized liquid, comprising two parts welded together by a welding method as claimed in claim 1.
